(19) United States
(12) Patent Application Publication
(10) Pub. No.: US 2014/0044851 A1
(43) Pub. Date: Feb. 13, 2014

(54) TEMPERATURE REGULATION SYSTEM FOR SLOW COOKER

(71) Applicant: Brian C Kennedy, Ann Arbor, MI (US)

(72) Inventor: Brian C Kennedy, Ann Arbor, MI (US)

(21) Appl. No.: 13/961,281

(22) Filed: Aug. 7, 2013

Related U.S. Application Data
(60) Provisional application No. 61/680,335, filed on Aug. 7, 2012.

(51) Int. Cl. A47J 27/00

(52) U.S. Cl. CPC A47J 27/004
USPC 426/523; 99/447; 99/332; 99/333

(57) ABSTRACT

The present invention includes an appliance that has a cook vessel and a temperature regulation system with a Peltier device. The active side of the Peltier cools and heats the cook vessel in the absence of a motive heat distribution system. The temperature regulation system may include a motive heat distribution system on its waste side where the top edge of the fan is located at or above the bottom edge of the any waste heat sink. Methods of cooling and heating food are also part of the invention.

### CLAIM OF PRIORITY

The present application claims the benefit of U.S. Provisional Application No. 61/680,335, filed on Aug. 7, 2012.

### FIELD OF THE INVENTION

The present invention relates to an improved temperature regulation system for a slow cooker.

### BACKGROUND OF THE INVENTION

As lifestyles become more hectic, there is an ever-increasing demand for time saving devices in the kitchen. One desirable technique is to prepare a meal the night before and put it in an oven or slow cooker at the appropriate time. This presents several problems, not the least of which is that one has to be home and remember to put the meal in the oven or slow cooker. For many decades, oven timers have easily dealt with these problems, but left the uncooked meal sitting at room temperature for a number of hours before the cooking process was started. Leaving uncooked food, especially meats, for too long a period of time is unsafe.

Consequently, combination appliances were created that included both a cooking element and a refrigeration element. These elements, however, were separate from each other; creating complex devices that were expensive to manufacture and difficult to maintain. For example, a microwave has been combined with a plumbed refrigeration system. Another combination has been a resistive heating element combined with a plumbed refrigeration system.

Peltier devices, also called thermoelectric devices (TED) or thermoelectric coolers (TEC), are solid-state devices that act as a heat pump when current is passed through the device. Essentially, during use, heat is pumped from one side of the Peltier device to the other. Consequently, one side tends to increase in temperature, the hot side, and the other side tends to decrease in temperature, the cold side. A very useful feature of the Peltier device is that reversing the direction of the current reverses the direction of heat flow and flips the hot and cold sides. For consistency, we herein adopt the often used labels “active” and “waste”. The active side provides heating and/or cooling to a desired element through some thermal connection.

Appliances utilizing Peltier devices have been produced. For example, U.S. Pat. No. 7,174,720 shows a slow cooker with a dual use Peltier that both heats and cools a cook vessel in the absence of an active side motive temperature regulation system. Temperature regulation, used herein means the input or removal of thermal energy, heating or cooling, to achieve a desired temperature for the active side of the Peltier.

However, known waste side temperature regulation systems pose problems related to the compactness of the overall system. Designed for use on a countertop, slow cookers are limited in height to fit underneath the upper cabinets.

The inventor has recognized solutions to one or more of the above-mentioned problems. The present invention overcomes one or more of these problems.

### SUMMARY OF THE INVENTION

The present invention includes an appliance that has a cook vessel and a temperature regulation system with a Peltier device. The active side of the Peltier cools and heats the cook vessel in the absence of a motive heat distribution system. The temperature regulation system may include a motive heat distribution system on its waste side where the top edge of the fan is located at or above the bottom edge of the any waste heat sink. Methods of cooling and heating food are also part of the invention.

### BRIEF DESCRIPTION OF THE DRAWINGS

In the drawings:

FIG. 1 shows a schematic cross-sectional view of a slow cooker.

FIG. 2 shows a compact view of one embodiment of the waste side distribution system with an axial fan.

FIG. 3 shows an exploded view of one embodiment of the waste side distribution system with an axial fan.

FIG. 4 shows an exploded view of one embodiment of the waste side distribution with a cross flow fan.

### DETAILED DESCRIPTION

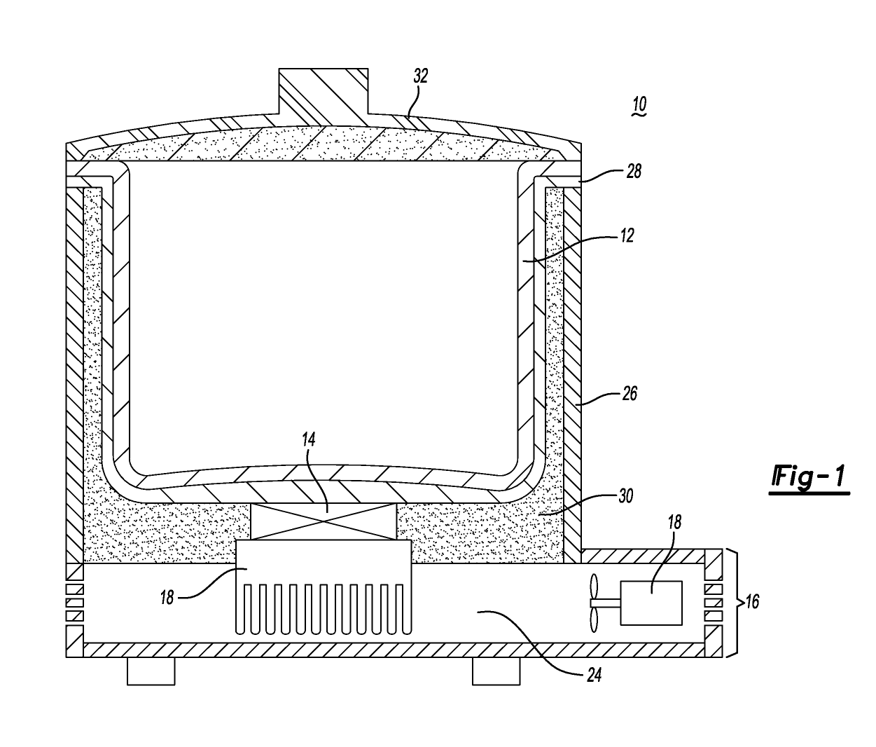

The present invention comprises an appliance that may both cool and heat food. As seen in FIG. 1, the appliance 10 includes a cook vessel 12 and a temperature regulation system including at least one Peltier device 14. The appliance may also include a waste side distribution system 16, which may include one or more of: a heat sink 18, a fan 20 and/or ducting 24. A power source provides the necessary energy to operate the temperature regulation system and/or the waste side distribution system. Optionally, the cook vessel, the Peltier device and the rest of the components may be contained with a housing 26, where the housing may contain an inner lining 28 (which may be made of a thermally conductive material), insulation 30 and cover 32. The appliance may also contain a control unit, one or more sensors such as temperature, current and/or voltage sensors, an interface such as a user interface or a remote interface, a display or combinations thereof. As can be seen, the inner lining may have a curve to its upper surface that matches a curve to the lower surface of the cook vessel. The ducting 24 and/or the housing 26 cooperate to form an air flow path across the heat sink where the motive force for the air is provided by the fan.

Cooling, as used herein, refers to decreasing the temperature of the cook vessel and/or its contents to a temperature less than the present temperature. Heating used herein refers to increasing the temperature of the cook vessel and/or it contents to a temperature greater than the present temperature. In a preferred embodiment, the appliance may increase the temperature to a degree sufficient to provide edible warm food. Collectively, cooling and heating may be referred to as temperature regulation.

Any vessel that remains intact at the operational temperatures of the appliance may be suitable for use as a cook vessel. The cook vessel is preferably made of a material that is lightweight and cost effective that adequately conducts heat to or from the contents of the cook vessel. Aluminum is a preferred material. Other materials may also be suitable for the cook vessel such as other metals, glass, ceramic, laminates or plastic.

Combination cook vessels may also be suitable, e.g. a metal vessel with a plastic non-stick coating on its food contacting surfaces. Alternately, a layer of fabric or foam insulation may be contained within the walls of the cook vessel.

Preferably, the cook vessel is removable, thus easing cleaning and use of the vessel for other activities. In one preferred embodiment, the bottom of the cook vessel is not planar and thus has a curve to it. This aids in heat distribution and resists warping overtime; warping can detrimentally effect the position of the cook vessel and the Peltier relative to one another (as described below), leading to reduced heat transfer. From the perspective of the outside of the cook vessel, it preferred that the bottom is concave. In this manner, the cook vessel will be stable when placed on a flat surface. The concave bottom could act to help seat the cook vessel within the housing or adjacent to the Peltier and/or the thermally conductive material. A convex bottom may also be used, especially if the bottom further includes a circumferential ring of about the same height as the convex portion of the bottom. Such an arrangement would make the cook vessel stable on a flat surface. Furthermore, such a circumferential ring could act to help seat the cook vessel within the housing or adjacent to the Peltier and/or the thermally conductive material (as discussed below).

Optionally, the appliance will also include a cover to minimize heat transfer and retain moisture during operation. The cover also keeps out contaminants. The cover may be latched and/or hinged to the housing or cook vessel. In one embodiment, the overall height of the cover in the open position and the housing is such that it fits comfortably between a counter top and the lower limit of the upper cabinets. That is the user is able to place the cover in the fully open position without interference from the upper cabinets. The latch may be located anywhere generally around the upper circumference of the vessel or housing.

A multipart cover may also be used to reduce the overall height of the cover, housing and/or appliance. In one such embodiment a roll-top cover is used such that the cover is stored rolled around an axis. In another such embodiment, two or more part of the cover are hinged connected together, hingedly connected to the housing or appliance or a combination thereof. For example, one part of the cover may be hingedly connected to another part of the cover, which in turn is hingedly connected to the housing or appliance. The benefit of such a cover is that the height of the cover in the open position is substantially reduced.

In an ideal situation, the overall height of the appliance with the cover in the open position is such that the user is able to insert and remove the cook vessel while the appliance is beneath the upper cabinets.

The temperature regulation system preferably includes a Peltier or thermoelectric device. Any Peltier type device may be utilized in the present appliance, without regard to size, shape, composition, power rating or other characteristic. Preferably, the selected Peltier device will be able to achieve a temperature in the cook vessel in the range of 0° C. to 150° C. In one preferred embodiment, the temperature of the Peltier device is about 90° C. Cost effective Peltier devices that achieve this temperature range are currently available in commercial quantities.

In addition to a single Peltier device, several Peltier devices may be included in the temperature regulation system or the appliance. Such a situation permits spaced placement of the Peltier devices about the cook vessel, which in turn may provide more consistent temperature regulation (i.e., less of a thermal gradient from one location in the cook vessel to another location in the cook vessel).

The Peltier device may be located anywhere within the appliance. In a preferred embodiment, a single Peltier device is located underneath the base or bottom of the cook vessel. In another embodiment, in addition to the base Peltier device, one or more Peltier devices may be located on the walls of the inner lining.

The cook vessel and Peltier device are located relative to one another within the appliance such that a motive distribution system (e.g. a system that moves a thermal transfer fluid) is not required to provide temperature regulation to the cook vessel. In one preferred embodiment, the Peltier device will contact the cook vessel directly. In another embodiment, the Peltier device will be spaced apart from the cook vessel. In still another embodiment, the temperature regulation system will include a thermally conductive material such that the Peltier device will be connected to the cook vessel by the thermally conductive material. Other non-motive heat distribution system may be used in place of the thermally conductive material. In a preferred embodiment, the Peltier device is conductively coupled to the cook vessel by one or more thermally conductive materials. One preferred implementation includes an inner lining of the housing separating the cook vessel from the Peltier device, where the inner lining serves as the thermally conductive material. In another preferred embodiment, an aluminum interface plate is used in combination with the inner lining to conductively couple the Peltier device to the cook vessel, where the interface plate is located between the Peltier device and the inner lining. Here, the lining and the interface plate together serve as the thermally conductive material. While solid thermally conductive materials are preferred, highly viscous liquids (e.g. gels or greases) may also be suitable. In addition, other materials may be used such as thermal grease or adhesive to attach the Peltier device to the interface plate or the inner lining.

The number and arrangement of the Peltier devices may be selected to permit the elimination of extraneous components of temperature regulation system. Also, the need for an active side motive distribution system to provide heating or cooling can be eliminated.

By eliminating an active side motive distribution system, the complexity of the appliance is greatly reduced, thus reducing the cost of manufacture, as well increasing the reliability of the appliance. The use of a thermally conductive material or a like device between the Peltier device and the cook vessel (e.g. the inner lining and/or the interface plate) would maintain the reduced complexity of the appliance while also potentially offering more consistent temperature regulation of the cook vessel.

The waste side distribution system provides for a method to improve the efficiency of Peltier device with limited increases in complexity or cost. The waste side distribution system is used during cooling to transfer heat to the ambient air and in the heating mode, to stabilize the waste side temperature. While a plumbed system or a system including a liquid thermal transfer medium may be utilized to transfer waste side heat to ambient, a less complex system is preferable. For example, a system that utilizes ambient air, a heat sink and/or a fan would provide a cost effective and straightforward heat removal system. Ducting may be utilized to provide an intake and an exhaust for the distribution system and to route the air over the heat sink. Alternately, a mesh or other air permeable structure may be used to enclose the heat sink, fan and/or other components of the appliance.

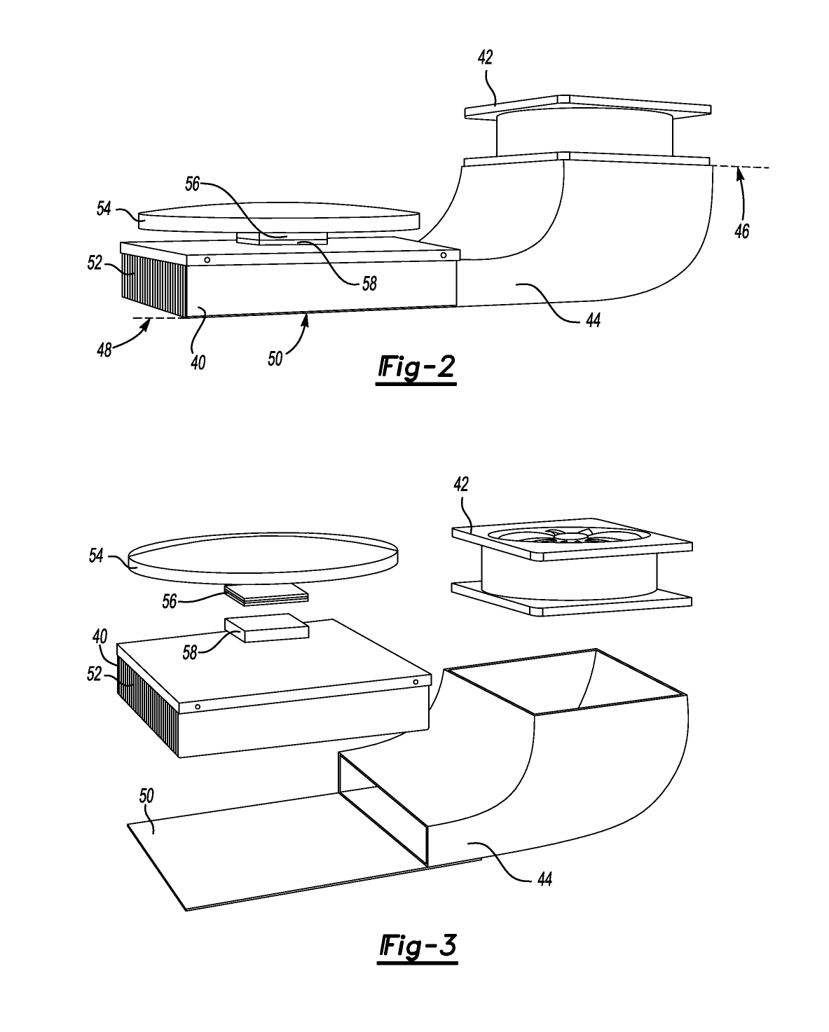

In order to decrease to overall height of the open cover and housing, the height of the waste side distribution system is also decreased without negatively effecting the efficiency of the waste side distribution system. In one embodiment, as seen in FIGS. 2 and 3, the waste side distribution system includes a heat sink 40 and a fan 42 that are connected by ducting 44, where the plane of the bottom edge 46 of the fan is above the plane of the bottom edge 48 of the heat sink. As seen in Figures, the fan is located away from the center line of the cook vessel. Instead of stacking the fan on the heat sink and the thermally conductive material, the fan is moved off center. This permits the entire height of the fan to be eliminated from the overall height of the housing and thus the appliance. In this embodiment, a portion 50 of the ducting 44 overlays the fins 52 of the heat sink. The fins are preferably oriented so that they run generally parallel to flow path of air drawn or blown by the fan. In the embodiment seen in FIGS. 2 and 3, the ducting is sized and shaped so that substantially all the air drawn or blown by the fan is moved across the heat sink. A thermally conductive material 54 is place on top of the Peltier 56. Another thermally conductive material 58 may be placed between the Peltier and the heat sink.

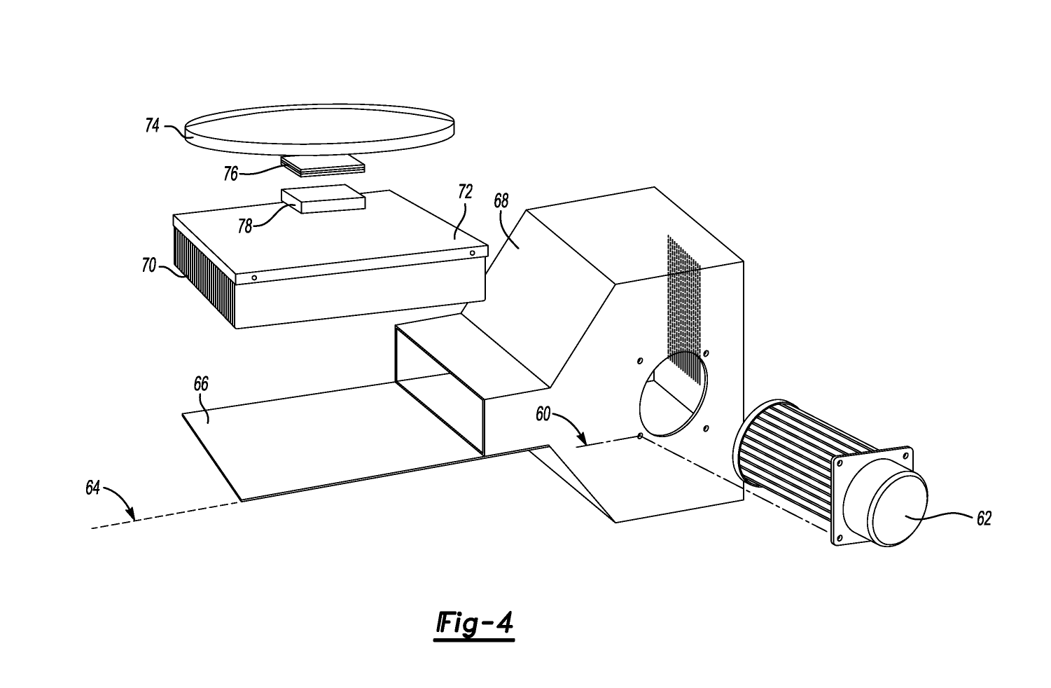

In another embodiment, as seen in FIG. 4, the plane of the bottom edge 60 of the fan 62 is at or below the plane of bottom edge 64 of the heat sink 66. The bottom edge 64 is roughly in the same location as a portion 66 of the ducting 68 that overlays the fins 70 of the heat sink 72. This may be the preferred embodiment if the overall height of the housing and cover in the open position is less than about 18 inches; for example, when a two part cover is utilized. Because some portion of the height of the fan is desired to be eliminated, at the very least, the plane of the top edge of the fan is always higher than the plane of the bottom edge of the heat sink. A thermally conductive material 74 is place on top of the Peltier 76. Another thermally conductive material 78 may be placed between the Peltier and the heat sink.

Both axial flow and centrifugal flow fans are contemplated as being useful in the waste side distribution system. Axial fans, such as seen in FIGS. 2 and 3, are sometimes preferred because of higher airflow in a taller package. This permits a slightly larger heat sink. This arrangement works especially well for countertops that are 12 inches or more in depth. With countertops of this depth, the appliance may be located substantially under the upper cabinet with a portion exposed. The exposed portion of the appliance may be taller then the distance between the countertop and the upper cabinet. Thus, a taller axial fan, with its better performance, may still be used.

For situations where it is desirable to have the appliance fully accepted underneath the upper cabinet, preferably a centrifugal flow fan is utilized such as a cylindrical fan (or cross flow fan). In these fans, the length is relatively large compared to the diameter of the fan. Here, sufficient motive force may be achieved without increasing the height of the fan or the appliance, as seen in FIG. 4. Exemplary cross flow fans are available from Y.S. Tech USA (http://www.ystechusa.com).

The appliance typically will include a housing, which brings the components of the appliance together into a convenient package. The housing may include insulation to increase the thermal efficiency of the appliance or otherwise make the appliance suitable for consumer use (e.g. sound deadening insulation.).

The power source for the appliance preferably draws power from a wall socket; however, other power sources may be utilized, such as batteries, fuel cells or other portable sources of power.

The control unit provides operational mode selection as a function of time for the appliance. Typically, the predetermined operational modes which can include cooling, heating, cooking, refrigeration, temperature hold are set to operate for pre-selected durations at pre-selected times. The control unit may also receive input from a variety of sensors including temperature, current and voltage sensors, as well as issuing signals to the interface.

The appliance includes one or more interfaces. A user interface permits the user to program the appliance while at the appliance. A remote interface permits the user to attach to (e.g. plug-in a computer cable) or otherwise communicate with (e.g. wirelessly) the appliance when the user is not at the appliance. An appliance may contain both a user interface and a remote interface. The control unit may receive inputs or instructions from the interface.

In one embodiment of the interface, the user programs the appliance, including the start time and stop time and, optionally, the temperature at the user interface, which in turn transmits the instructions to the control unit. The user interface may be as simple as manual control without a timer or an electromechanical timer. Mechanical interface components (e.g. dial, sliders or the like) may also be used for selecting the temperature. The functions of the user interface may be combined into one component (e.g. one dial) or the functions may be separated into individual components (e.g. a dial for the timer and a dial for temperature). In another embodiment, the user interface may include an alphanumerical keypad, a touch pad or another electronic input device used for programming the operation of the appliance.

In another embodiment of the interface, a remote interface may be utilized to permit instructions to be sent to the control unit from a remote location. The remote interface may include one or more ports to accept a phone line or a computer cable that allow wireline communication with a device located remotely. The remote interface may also include a wireless communication module, no matter what part of the electromagnetic spectrum is utilized to transmit the signals (e.g. IR, RF, Bluetooth, cellular, Wi-Fi or the like). Communication transmitted through the power supply may also suitably be used to connect to a remote device.

Suitable devices located remotely include any device capable of issuing instructions that may be transmitted to the appliance. For example, a programmable computer, a telephone (cellular or landline), a remote control, combinations thereof or the like may be used.

Preferably, the remote interface uses standard communications protocols (e.g. TCP/IP), standard communications devices (e.g. modem, Ethernet card, wireless card), and communications networks (e.g. the internet or other packet switched network or the public switched telephone network). Such a remote interface permits a user to change the instructions to the appliance without having to be in the same location as the appliance, whether the appliance is across the room, in the next room, across the street or across the country from the device located remotely. As well as receiving instructions, the remote interface may be used to report information regarding the current state of the appliance including temperature, time remaining or whether a fault or other error has occurred.

The appliance may include a display to report the current conditions such as temperature, time remaining or whether an error has occurred. This display may also include a visual or auditory cue that an error has occurred, that the cooking cycle has begun or ended or that any other noteworthy event has happened.

Operating the appliance is straightforward. Uncooked food is placed in the cook vessel, which in turn is placed in the housing and near to the Peltier device. Power is supplied to the Peltier device and the temperature of the cook vessel is regulated. An unlimited number of time and/or temperature profiles maybe used to achieve the desired results, whether that is cold storage, a hot meal, or refrigerated leftovers. One preferred temperature profile includes cooling from ambient temperature to a desired low point (e.g. 2-4° C.) where the temperature is held until heating is initiated. Heating is continued until the food is sufficiently cooked to be edible. At this point, heating may be stopped altogether, cooling may be initiated or a steady temperature may be achieved. In addition, temperature profiles may be steady increases or decreases, stepped increases or decreases or maintaining a particular temperature.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. Plural structural components or steps can be provided by a single integrated structure or step. Alternatively, a single integrated structure or step might be divided into separate plural components or steps. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

What is claimed is:

1. An appliance comprising:
a housing,
a temperature regulation system having an active side and a waste side, wherein the active side comprises a convex portion and having a Peltier device;
a cook vessel in contact with the active side of the temperature regulation system, the cook vessel comprising a concave portion disposed at the bottom portion of the cook vessel matched to the convex portion of the temperature regulation system; and
a waste side distribution system in thermal communication with the waste side of the temperature regulation system. a cover hingedly attached to the housing or cook vessel; and a waste side distribution system;
wherein the Peltier is located underneath the cook vessel and provides temperature regulation to the cook vessel and
wherein the waste side distribution system comprises a heat sink and a fan, wherein the plane of the top edge of the fan is above the plane of the bottom edge of the heat sink.

2. The appliance of claim 1 wherein the plane of the bottom edge of the fan is at or above the plane of the bottom edge of the heat sink.

3. The appliance of claim 1 wherein the plane of the bottom edge of the fan is at or below the plane of the bottom edge of the heat sink.

4. The appliance of claim 1 wherein the height of the hingedly attached cover in an open position and the height of the housing combined are less than about 18 inches.

5. The appliance of claim 4 wherein the cover is a multipart cover.

6. The appliance of claim 5 wherein the multipart cover includes at least two hinges.

7. The appliance of claim 6 further comprising a control unit having at least a timer.

8. The appliance of claim 7 further comprising a temperature sensor connected to the control unit.

9. The appliance of claim 8 further comprising a user interface.

10. The appliance of claim 9 further comprising a remote interface.

11. A method comprising:
contacting a cook vessel, having a concave portion disposed at the bottom portion of the cook vessel, with a temperature regulation system having a convex portion matched to the concave portion of the cook vessel, a Peltier, and a waste side distribution system,
wherein the convex portion of the temperature regulation system comprises a thermally conductive material separating the Peltier from the cook vessel; and
wherein the waste side distribution system comprises a heat sink and a fan, wherein the plane of the top edge of the fan is above the plane of the bottom edge of the heat sink; and.
cooking uncooked ingredients in the cook vessel until edible.

12. The method of claim 11 further comprising controlling the cooking with a control unit having a user interface, a remote interface or combinations thereof.

13. The method of claim 11 further comprising refrigerating the cook vessel before the cooking step.

14. The method of claim 11 further comprising refrigerating the cook vessel after the cooking step.
